(19) United States
(12) Patent Application Publication
(10) Pub. No.: US 2026/0188257 A1
(43) Pub. Date: Jul. 2, 2026

(54) DISPLAY DEVICE AND DRIVING METHOD THEREOF

(71) Applicant: LG Display Co., Ltd., Seoul (KR)

(72) Inventors: Tae Gung KIM, Paju-si (KR); Jae Yeon SONG, Paju-si (KR); Kyu Hwan JOO, Paju-si (KR)

(73) Assignee: LG Display Co., Ltd., Seoul (KR)

(21) Appl. No.: 19/438,096

(22) Filed: Dec. 31, 2025

(30) Foreign Application Priority Data
Dec. 31, 2024 (KR) 10-2024-0202703

(51) Int. Cl. G09G 3/3266

(52) U.S. Cl. CPC G09G 3/3266; G09G 2310/0286; G09G 2310/08; G09G 2320/0233; G09G 2320/0247; G09G 2320/0257

(57) ABSTRACT

Discussed are a display device and a driving method thereof. The display device includes a display panel having data lines, gate lines, and pixel lines with pixels, a data driver connected to the data lines, a gate driver connected to the gate lines, and a timing controller configured to receive first pixel data of an input video or second pixel data of the input video from a set and control the data driver and the gate driver based on the received pixel data. The timing controller is configured to write, when the second pixel data is received from the set at a transmission speed faster than the first pixel data, the second pixel data to the pixels during a writing period in one frame. Then the timing controller is configured to write black data having a black grayscale value to the pixels during a vertical blank period.

### CROSS-REFERENCE TO RELATED APPLICATION

This application claims priority to and the benefit of Korean Patent Application No. 2024-0202703, filed in the Republic of Korea on December, 31, 2024, the disclosure of which is hereby expressly incorporated by reference in its entirety.

### BACKGROUND

### Field

The present disclosure relates to a display device and a driving method thereof.

### Discussion of the Related Art

Various flat panel displays such as a liquid crystal display and an electroluminescence are known. The electroluminescence display uses a light-emitting element provided in each of pixels to emit light by itself without a backlight and displays an input video. The light-emitting element of the electroluminescence display is divided into an organic light-emitting element and an inorganic light-emitting element according to a material for a light-emitting layer.

To improve the image quality of the display device, a black data insertion (hereinafter, referred to as “BDI”) technique has been applied.

For example, for black data insertion utilizing a timing controller (TCON) of the related art based on the BDI technique, a set (SET) outputs the same frame through Frame doubling, and the timing controller (TCON) processes one frame of two input frames as a black frame.

The black frame passes through an internal algorithm block of the timing controller (TCON), which can cause a problem. For example, in the case of pixel level compensation (PLC) with luminance adjustment, because a previous frame is constantly black, an average picture level (APL) is recognized as 0% and an error occurs.

Furthermore, a problem also can occur in a time-division compensation related algorithm. For example, in the case of dither, when a frame is time-divided to expand a grayscale, a portion that is omitted due to the black frame can occur and an error can occur in image quality.

### SUMMARY OF THE DISCLOSURE

Embodiments of the present disclosure address the above-described shortcomings and/or problems.

The present disclosure provides a display device and a driving method thereof capable of improving image quality.

The problems addressed by the present disclosure are not limited to those described above, and other problems not described will be clearly understood by those skilled in the art from the following description.

A display device according to an embodiment of the present disclosure includes a display panel in which a plurality of data lines, a plurality of gate lines, and a plurality of pixel lines each having a plurality of pixels disposed therein are disposed; a data driver connected to the data lines; a gate driver connected to the gate lines; and a timing controller configured to receive first pixel data of an input video or second pixel data of the input video from a set, and control the data driver and the gate driver based on the received pixel data, wherein the timing controller is configured to write, when the second pixel data is received from the set at a transmission speed faster than the first pixel data, the second pixel data to the pixels during a writing period of one frame including a vertical blank period generated by the faster transmission speed, and then, write black data having a black grayscale value to the pixels during the vertical blank period.

A method for driving a display device according to an embodiment of the present disclosure includes writing first pixel data of an input video or second pixel data of the input video under the control of a set; setting a transmission frequency of the second pixel data of the input video to be higher than a transmission frequency of the written first pixel data of the input video; expanding a vertical blank period that is a surplus period other than a writing period, in one frame through the higher transmission frequency; writing the first pixel data or the second pixel data to pixels of a display panel during the writing period of the one frame under the control of the timing controller; and writing black data having a black grayscale value to the pixels during the vertical blank period.

According to the embodiments of the present disclosure, a frame frequency with an expanded blank period in one frame period is provided from the set in which an output frame frequency is set to be increased relative to an input frame frequency, and the black data is written during the vertical blank period. Therefore, motion blur and afterimage in a moving picture reproduced in the display panel can be decreased by reducing a moving picture response time (MPRT) of the pixels, and the clarity of a reproduced image can be improved.

According to the embodiments of the present disclosure, luminance deviation between pixels according to whether BDI is applied, luminance deviation due to a difference between an emission period of the pixels and a BDI period, and reduction in grayscale expression due to insufficient low grayscale charging can be compensated for, thereby improving the luminance uniformity and grayscale expression of the pixels.

The effects of the present disclosure are not limited to the effects mentioned above, and other effects not mentioned can be clearly understood by those skilled in the art to which the technical idea of the present disclosure pertains from the following description.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a block diagram illustrating a display device according to one or more embodiments of the present disclosure.

FIG. 2 is a circuit diagram illustrating a pixel circuit according to the one or more embodiments of the present disclosure.

FIG. 3 is a diagram schematically illustrating the gate driver according to an example of the present disclosure.

FIG. 4 is a block diagram illustrating the host system and the timing controller according to the one or more embodiments of the present disclosure.

FIGS. 5 and 6 are diagrams illustrating the first and second pixel data of the input video and a method for driving a display device according to the one or more embodiments of the present disclosure.

FIG. 7 is a diagram illustrating the internal data enable signal according to the one or more embodiments of the present disclosure.

FIG. 8 is a diagram illustrating driving in a first driving mode and a second driving mode according to the one or more embodiments of the present disclosure.

FIG. 9 is a diagram illustrating change in PLC Gain according to the one or more embodiments of the present disclosure.

FIG. 10, including (a), (b), and (c), illustrates diagrams illustrating a case where the black data is written during the vertical blank period at various frequencies according to the one or more embodiments of the present disclosure.

FIG. 11 is a diagram illustrating controlling a ratio of the black period in which the black data is written during the vertical blank period, according to the one or more embodiments of the present disclosure.

FIG. 12 is a diagram illustrating a simulation value of a moving picture response time (MPRT) with the refresh rate and black insertion application according to the one or more embodiments of the present disclosure.

FIG. 13, including (a), (b), and (c), illustrates diagrams illustrating a relationship between the MPRT and flicker according to the one or more embodiments of the present disclosure.

FIGS. 14 and 15 are diagrams illustrating driving in the normal mode and the fast MPRT mode according to the one or more embodiments of the present disclosure.

### DETAILED DESCRIPTION OF THE EMBODIMENTS

Advantages and features of the present invention, and methods of accomplishing the same, will become apparent by referring to the embodiments described hereinafter in detail with reference to the accompanying drawings. The present invention is not limited to the embodiments disclosed herein but can be embodied in many different forms. Rather, these embodiments are provided so that this disclosure will be thorough and complete, and will fully convey the scope of the invention to those skilled in the art.

The shapes, sizes, ratios, angles, numbers, etc., disclosed in the drawings to illustrate the embodiments of the present invention are examples, and the present invention is not limited to the matters shown in the drawings. Throughout the disclosure, the same reference numerals refer to substantially the same constituent elements. Furthermore, in the description of the present invention, when it is determined that a detailed description of related known technology can unnecessarily obscure the gist of the present invention, the detailed description thereof will be omitted.

In this specification, when terms such as “comprising,” “including,” “having,” or “consisting of” are used, other parts can be added unless “only” is used. When an element is expressed in the singular, it can be interpreted as the plural unless explicitly stated otherwise.

In interpreting components, they shall be construed as including error ranges or tolerances, even if not explicitly stated.

When positional relationships and interconnections between two components are described using terms such as ‘on,’ ‘above,’ ‘below,’ ‘beside,’ ‘connected to,’ ‘coupled to,’ ‘crossing,’ or ‘intersecting,’ one or more other components can be interposed between the components, unless terms such as ‘directly’or ‘immediately’are used.

When a temporal relationship is described suing terms such as ‘after,’ ‘subsequent to,’ ‘next,’ or ‘before,’ the events may not be continuous on the time axis unless ‘directly’ or ‘immediately’ is used.

Terms such as ‘first’ and ‘second’, etc. can be used to distinguish components, but these components are not limited in their function or structure by the ordinal numbers or names preceding them. Further, the term “can” fully encompasses all the meanings and coverages of the term “may” and vice versa.

The following embodiments can be partially or wholly combined or coupled with each other, and various technical interworkings and operations are possible. Each embodiment can be implemented independently of the others, or they can be implemented together in an associated relationship.

Hereinafter, various embodiments of the present disclosure will be described in detail with reference to the accompanying drawings. All the components of each display device/apparatus according to all embodiments of the present disclosure are operatively coupled and configured.

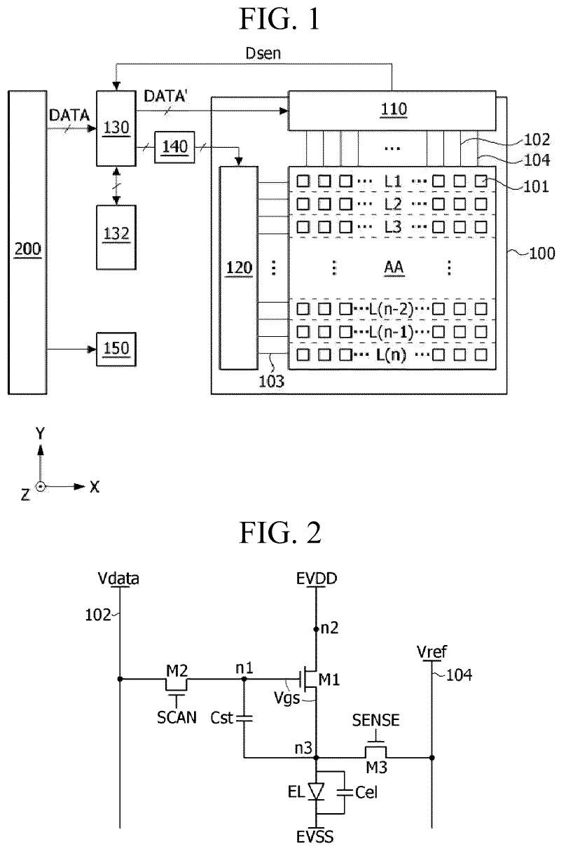

FIG. 1 is a block diagram illustrating a display device according to an embodiment of the present disclosure.

Referring to FIG. 1, the display device according to the embodiment of the present disclosure can include a display panel 100 and a display panel driving circuit for writing pixel data to pixels of the display panel 100.

The display panel 100 can be a rectangular panel having a length in an X-axis direction, a width in a Y-axis direction, and a thickness in a Z-axis direction. A display area AA (or active area) of the display panel 100 can include a pixel array that displays an input video. The pixel array can include a plurality of data lines 102, a plurality of gate lines 103 that intersect the data lines 102, a plurality of sensing lines 104, and pixels disposed in a matrix. The display panel 100 can further include power lines connected in common to the pixels. The power lines are connected in common to pixel circuits and can supply a voltage necessary for driving pixels 101 to the pixels 101.

Each of the pixels 101 can be divided into a red (R) sub-pixel, a green (G) sub-pixel, and a blue (B) sub-pixel. Each of the pixels 101 can further include a white (W) sub-pixel. Each of the sub-pixels can include a pixel circuit that drives first and second light-emitting elements configured to selectively emit light according to a selected viewing angle mode. The light-emitting elements can be light-emitting elements such as an organic light emitting diode (OLED) or a micro light emitting diode (LED), but embodiments of the present disclosure are not limited thereto.

Hereinafter, a pixel can be interpreted as a sub-pixel. The pixel circuit can be implemented as a circuit illustrated in FIG. 2, but embodiments of the present disclosure are not limited thereto.

The display area AA can include a plurality of pixel lines L1 to L(n). Here, n can be a real number such as a positive integer. Each of the pixel lines L1 to L(n) can include pixels of one line disposed in the X-axis direction in the pixel array of the display panel 100. The pixels 101 disposed in one pixel line can share the gate lines 103. The pixels disposed in the Y-axis direction can share the same data line 102. Here, one horizontal period is a time obtained by dividing one frame period by the total number of pixel lines L1 to L(n).

Touch sensors for sensing a touch input can be disposed on the display panel 100. The touch sensors can be disposed on the display panel 100 as an on-cell type or an add-on type or can be implemented as in-cell type touch sensors embedded in the pixel array.

The data lines 102 can be disposed in the form of long wires in the Y-axis direction of the display panel 100 and can be electrically connected to data channel terminals of a data driver 110.

The sensing lines 104 can be disposed on the display panel 100 in parallel to the data lines 102 and can be electrically connected to the sub-pixels and sensing channel terminals of the data driver 110.

The gate lines 103 can be disposed in the form of long wires in the X-axis direction of the display panel 100, can intersect the data lines 102, and can be electrically connected to output terminals of a gate driver 120.

The display panel driving circuit can write pixel data of an input video to the pixels of the display panel 100 under the control of a timing controller 130. The display panel driving circuit can include the data driver 110 and the gate driver 120. The pixel data of the input video can include first pixel data of the input video and second pixel data of the input video.

The display panel driving circuit can further include a touch sensor driver for driving the touch sensors. The data driver 110 and the touch sensor driver can be integrated in one drive integrated circuit (IC).

The data driver 110 can include a plurality of data channels and a plurality of sensing channels. The data channels can receive the pixel data of the input video in the form of a digital signal from the timing controller 130 and can output a data voltage. The data voltage can be supplied to the data lines 102. The sensing channels can convert signals received from the sensing lines 104 into digital signals and can output the digital signals. Sensing data Dsen output from the sensing channels can be transmitted to the timing controller 130.

The data channels of the data driver 110 can convert pixel data DATA′ of the input video into a gamma compensation voltage using a digital-to-analog converter (hereinafter, referred to as “DAC”) and can output the data voltage of the pixel data.

A gamma reference voltage can be divided into grayscale-specific gamma compensation voltages through a voltage division circuit. The grayscale-specific gamma compensation voltages can be provided to the DAC of the data driver 110. The data voltage can be output from each of the data channels of the data driver 110 via an output buffer and can be supplied to the data lines 102.

The sensing channels of the data driver 110 can include an analog-to-digital converter (hereinafter, referred to as “ADC”). The sensing channels can convert sensing voltages received from the sub-pixels through the sensing lines 104 using the ADC into digital data and can output the sensing data Dsen. The sensing data Dsen can be transmitted to the timing controller 130.

The gate driver 120 can be disposed in at least one non-display area (or a bezel area) on the right and left sides outside the display area AA in the display panel 100 or at least a part of the gate driver 120 can be disposed in the display area AA.

The gate driver 120 can be disposed in the non-display areas on both sides of the display panel 100 with the display area AA of the display panel interposed therebetween and can supply pulses of gate signals from both sides of the gate lines 103 by a double feeding method.

In another embodiment, the gate driver 120 can be disposed on at least one side of the right and left non-display areas of the display panel 100 and can supply the pulses of the gate signals to the gate lines 103 by a single feeding method.

The gate driver 120 can sequentially output the pulses of the gate signals to the gate lines 103 under the control of the timing controller 130. The gate driver 120 can sequentially supply the pulses of the gate signals to the gate lines 103 by shifting the pulses of the gate signals using a shift register.

The gate signals can include a first gate signal SCAN and a second gate signal SENSE illustrated in FIG. 2.

A host system 200 can scale an image signal from a video source to match the resolution of the display panel 100 and transmit the image signal to the timing controller 130 along with a timing signal.

The host system 200 can include one or more among a personal computer (PC) or a computer/processor, a set (SET), and a frame memory. For example, the set (SET) can write an input signal received from the PC to the frame memory, and then, increase a transmission speed of data at the time of output to secure or expand a vertical blank period that is a surplus time excluding a pixel driving period in one frame. This will be described below.

The timing controller 130 can receive the first and second pixel data of the input video from the host system 200 and a timing signal synchronized with digital video data of the input video. Here, the timing signal can include a vertical synchronization signal Vsync, a horizontal synchronization signal Hsync, a data enable signal DE, and the like.

Because a vertical period and a horizontal period can be known by a method of counting the data enable signal DE, the vertical synchronization signal Vsync and the horizontal synchronization signal Hsync can be omitted.

The horizontal synchronization signal Hsync and the data enable signal DE can have a cycle of one horizontal period 1H.

The timing controller 130 can control an operation timing of each of the data driver 110 and the gate driver 120 based on the timing signal (Vsync, Hsync, and DE) received from the host system 200. The timing controller 130 can generate a data timing control signal for controlling the operation timing of the data driver 110 and a gate timing control signal for controlling the operation timing of the gate driver 120.

Furthermore, the timing controller 130 can generate an internal data enable signal IN-DE using at least one embedded algorithm when a command signal that is a control command signal related to black data is received from the set (SET) via a communication interface.

The timing controller 130 can generate a data timing control signal for controlling the data driver 110 and a gate timing control signal for controlling the gate driver 120 based on the generated internal data enable signal IN-DE. For example, the timing controller 130 can generate a gate-in-panel (GIP) signal based on the generated internal data enable signal IN-DE.

The timing controller 130 can be connected to a memory 132. The memory 132 can store a program code that executes an algorithm for improving image quality, a program code that executes an algorithm for generating a compensation value and the internal data enable signal IN-DE, and the like.

For example, the compensation value can include a gain that is multiplied to the pixel data and an offset that is added to the pixel data.

The memory 132 can include a non-volatile memory and a volatile memory. The non-volatile memory can include one or more of readable and writable memories, for example, a NAND flash memory, a NOR flash memory, and an electrically erasable programmable read-only memory (EEPROM). The NAND flash memory can be a single level cell (SLC) type. The volatile memory can include one or more of a dynamic RAM (DRAM), a static RAM (SRAM), a synchronous dynamic RAM (SDRAM), and a double data rate SDRAM (DDR SDRAM).

The timing controller 130 can receive pixel data DATA of the input video and transmit modulated pixel data DATA′ to the data driver 110 for improvement of image quality.

For example, the timing controller 130 can modulate the pixel data of the input video with a compensation value derived based on optical compensation data set in advance or the sensing data Dsen obtained from the pixels 101 and transmit the modulated pixel data DATA′ to the data driver 110.

The timing controller 130 can accumulate the pixel data or the compensation value for each frame period by sub-pixel to calculate stress data, thereby determining accumulated stress by sub-pixel. The timing controller 130 can overwrite the stress data in the non-volatile memory at predetermined time periods, for example, at periods of 30 minutes to update the stress data.

The timing controller 130 can write the first pixel data to the pixels in one frame when the first pixel data is received from the set.

When the second pixel data is received at a transmission speed faster than the first pixel data, the timing controller 130 can write the second pixel data to the pixels in one frame including a blank period generated by the fast transmission speed, and then, can write black data having a black grayscale value to the pixels during the blank period. Detailed description will be provided below.

The display panel driving circuit can further include a level shifter 140 and a power supply 150.

The level shifter 140 can convert a voltage level of an output signal of the timing controller 130, for example, the gate timing control signal. The level shifter 140 can level-shift a voltage of an input signal received from the timing controller 130 to output the voltage of the output signal as a voltage greater than the voltage of the input signal.

For example, the input signal of the level shifter 140 can be a signal of a digital signal voltage level, and the output signal of the level shifter 140 can be an analog voltage signal that swings between a gate high voltage and a gate low voltage.

The gate timing control signal output from the level shifter 140 can be input to the gate driver 120. The gate timing control signal can include a start pulse and a clock. The gate timing control signal can further include a gate output enable signal.

The power supply 150 can include a charge pump, a regulator, a buck converter, a boost converter, and the like, but embodiments of the present disclosure are not limited thereto.

The power supply 150 can receive a direct-current input voltage from the host system 200 and generate power necessary for driving the data driver 110, the gate driver 120, and the pixels 101. For example, the power supply 150 can output constant voltages (or DC voltages) such as a gamma reference voltage, a gate high voltage, a gate low voltage, and power for the pixel circuit.

The gamma reference voltage can be supplied to the data driver 110. The gate high voltage and the gate low voltage can be supplied to the level shifter 140 and the gate driver 120. The power for the pixel circuit can include a pixel driving voltage, a pixel ground voltage, a reference voltage, and the like. The power for the pixel circuit can be applied to the pixels via the power lines connected in common to the pixels.

The power supply 150 can vary an output voltage level under the control of the timing controller 130. The power supply 150 can be implemented as a voltage IC such as a power management integrated circuit (PMIC) or an electronics integrated circuit (ELIC), but embodiments of the present disclosure are not limited thereto.

FIG. 2 is a circuit diagram illustrating a pixel circuit according to the embodiment of the present disclosure.

Referring to FIG. 2, the pixel circuit can include a light-emitting element EL, a driving transistor M1, a storage capacitor Cst, a first switch transistor M2, and a second switch transistor M3.

In FIG. 2, a pixel driving voltage EVDD can be 24 V and a pixel ground voltage EVSS can be 0 V, but embodiments of the present disclosure are not limited thereto. A dynamic range of a data voltage Vdata can be 2 to 10 V, but embodiments of the present disclosure are not limited thereto. A voltage level of the data voltage Vdata can be determined according to the value of the pixel data.

The light-emitting element EL can include an anode electrode, a light-emitting layer, and a cathode electrode. The anode electrode of the light-emitting element EL can be connected to a third node n3. The pixel ground voltage EVSS can be applied to the cathode electrode of the light-emitting element EL.

The driving transistor M1 can generate a current flowing into the light-emitting element EL according to a gate-source voltage Vgs to drive the light-emitting element EL.

The driving transistor M1 includes a gate electrode connected to a first node n1, a first electrode connected to a second node n2 to which the pixel driving voltage EVDD is applied, and a second electrode connected to the third node n3. The first electrode can be interpreted as a drain electrode, and the second electrode can be interpreted as a source electrode.

The storage capacitor Cst can be connected between the first node n1 and the third node n3 and can store the gate-source voltage Vgs of the driving transistor M1.

The first switch transistor M2 can supply a data voltage Vdata corresponding to a grayscale value of the pixel data to the first node n1 in response to the pulse of the first gate signal SCAN. The first switch transistor M2 can include a first electrode connected to the data line 102 to which the data voltage Vdata is applied, a gate electrode to which the first gate signal SCAN is applied, and a second electrode connected to the first node n1.

The second switch transistor M3 can connect the third node n3 to the sensing line 104 in response to the pulse of the second gate signal SENSE. The second switch transistor M3 can include a first electrode connected to the third node n3, a gate electrode to which the second gate signal SENSE is applied, and a second electrode connected to the sensing line 104. A reference voltage Vref can be applied to the sensing line 104.

The first switch transistor M2 and the second switch transistor M3 can be implemented as n-type transistors or p-type transistors according to channel characteristics.

The pulses of the gate signals SCAN and SENSE can be set to a gate on voltage. The first switch transistor M2 and the second switch transistor M3 can be turned on in response to the gate on voltage and can be turned off in response to a gate off voltage.

For example, in the case of an n-channel transistor, the gate on voltage can be the gate high voltage, and the gate off voltage can be the gate low voltage. In the case of a p-channel transistor, the gate on voltage can be the gate low voltage, and the gate off voltage can be the gate high voltage.

The first gate signal SCAN and the second gate signal SENSE can be generated with different phases and/or pulse widths. In this case, the gate driver 120 can sequentially output the pulse of the first gate signal SCAN using a first shift register, and can sequentially output the pulse of the second gate signal SENSE using a second shift register.

The first gate signal SCAN and the second gate signal SENSE can be the same gate signal. In this case, because the gate driver 120 can sequentially output the pulse of the first gate signal SCAN and the pulse of the second gate signal SENSE using one shift register, the non-display area of the display panel 100 where the gate driver 120 is disposed can be reduced, and an aperture ratio can be increased with a reduction in the number of gate lines.

With the display device of the present disclosure, in the set, the vertical blank period that is a surplus period remaining after the pixel data is written to the pixels, during one frame period can be secured by increasing the transmission frequency of the pixel data and can be then provided to the timing controller, and black data can be written during the vertical blank period. Therefore, motion blur and afterimage in a moving picture reproduced in the display panel 100 can be reduced by increasing a moving picture response time (MPRT) of the pixels, and the clarity of the reproduced moving picture can be improved.

During a pixel driving period in which the input video is reproduced in the pixels 101 of the display panel 100, the pixel data is written to the pixels 101. During the pixel driving period, the data voltage Vdata corresponding to the pixel data of the input video can be applied to the gate electrode of the driving transistor M1, and the light-emitting element EL can emit light.

In contrast, data (hereinafter, referred to as “black data”) having a black grayscale value irrelevant to the input video can be written to the pixels 101 during the blank period. During a vertical blank period V-Blank, a black grayscale voltage corresponding to the black data can be applied to the gate electrode of the driving transistor M1 to decrease the gate-source voltage Vgs of the driving transistor M1 to a voltage lower than a threshold voltage of the driving transistor M1.

Accordingly, during the vertical blank period, the driving transistor M1 is controlled in an off state in the pixels 101. As a result, because a current is not generated through the driving transistor M1, the light-emitting element EL may not emit light.

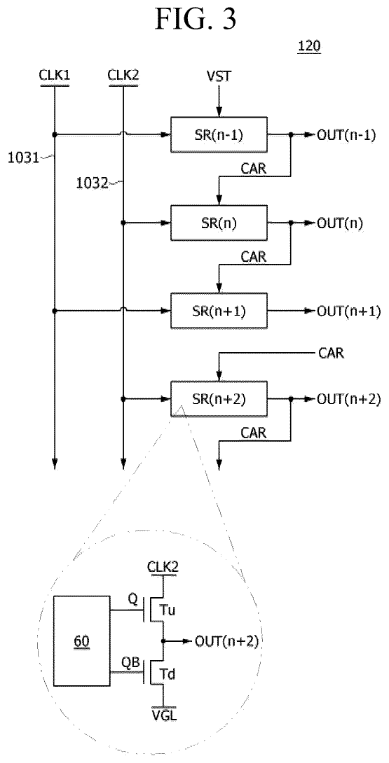

FIG. 3 is a diagram schematically illustrating the gate driver according to an example of the present disclosure.

Referring to FIG. 3, the shift register of the gate driver 120 can include stages SR(n−1) to SR(n+2) connected in a cascade manner.

Clocks CLK1 and CLK2 can be input via clock wires 1031 and 1032 connected to the stages SR(n−1) to SR(n+2). The start pulse can be applied to a first stage. In FIG. 3, the first stage can be an (n−1)th stage SR(n−1).

The stages SR(n−1) to SR(n+2) can be operated such that a Q node is charged in response to the start pulse or a carry signal CAR from a previous stage, and can output pulses of gate signals OUT(n−1) to OUT(n+2) in synchronization with the pulse of the clock CLK1 or CLK2 in a state in which the Q node is charged. The clock CLK1 or CLK2 can be an n (where n is an integer equal to or greater than two)-phase clock in which a phase is sequentially shifted.

Each of the stages SR(n−1) to SR(n+2) can include a controller 60 that charges and discharges the Q node and a QB node using a plurality of transistors, and a buffer that charges the gate line according to a voltage of the Q node to cause rising of a waveform of a gate signal and discharges the gate line according to a voltage of the QB node to cause falling of the waveform of the gate signal.

The buffer can include a pull-up transistor Tu and a pull-down transistor Td.

The pull-up transistor Tu can be turned on when the voltage of the Q node is charged to be equal to or greater than the gate on voltage, to charge an output node with the voltage of the clock CLK1 or CLK2 and cause rising of the pulse of the gate signal [OUT(n−1) to OUT(n+2)].

The pull-down transistor Td can be turned on when the voltage of the QB node is charged to be equal to or greater than the gate on voltage, to discharge the output node to the gate off voltage, for example, a gate low voltage VGL and cause falling of the pulse of the gate signal [OUT(n−1) to OUT(n+2)].

The pulses of the gate signals OUT(n−1) to OUT(n+2) output from the stages SR(n−1) to SR(n+2) can be sequentially applied to the gate lines by the clocks CLK1 and CLK2.

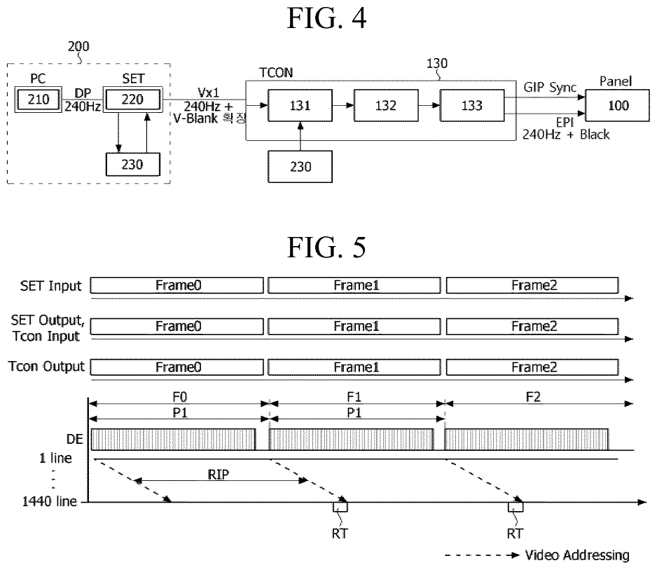

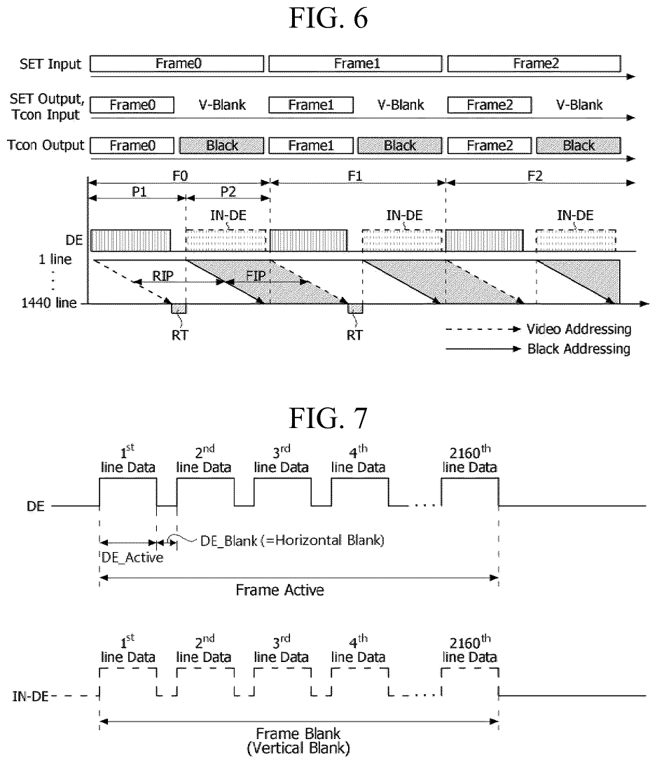

FIG. 4 is a block diagram illustrating the host system and the timing controller according to the embodiment of the present disclosure. FIGS. 5 and 6 are diagrams illustrating the first and second pixel data of the input video and a method for driving a display device according to the embodiment of the present disclosure.

Referring to FIG. 4, the host system 200 can include a PC 210, a set 220, and a frame memory 230.

The PC 210 can provide an input video, which is an image signal from a video source, to the set 220. The PC 210 can be a computer, processor, personal computer, laptop, electronic device, navigation system, mobile device, etc.

The set 220 can write the first pixel data of the input video or the second pixel data of the input video input from the PC 210 to the frame memory 230. The set 220 can transmit the first pixel data of the input video or the second pixel data of the input video written to the frame memory 230 to the timing controller 130 via a serial interface. For example, the set 220 can directly output the input video input from the PC 210 or can change a timing after writing the first pixel data or the second pixel data to the frame memory 230 and transmit the first pixel data or the second pixel data, which has an increased transmission speed compared to the first pixel data to the timing controller 130 via a serial interface and the vertical blank period V-Blank is further secured,. The serial interface can be implemented as a V-by-one (V×1) method with which fast and large-capacity data interfacing can be performed, but embodiments of the present disclosure are not limited thereto.

The set 220 can make a data transmission speed of the first pixel data of the input video and a data transmission speed of the second pixel data of the input video different from each other. Detailed description thereof will be provided below.

The timing controller 130 can include a video compensation part 131, an internal signal generation part 132, and a signal output part 133.

When the first pixel data of the input video or the second pixel data of the input video is provided, the video compensation part 131 can analyze the first pixel data or the second pixel data and compensate for the first pixel data or the second pixel data by applying afterimage processing of locally reducing luminance, afterimage compensation for calculating compensation data of each pixel to prevent OLED deterioration, external compensation for adding a Vth value to data to correct TFT deterioration, and the like.

For example, the video compensation part 131 can perform compensation using a high dynamic range (HDR) technique for expanding the range of brightness and color expressible by the display to show more vivid and realistic videos or a pixel level compensation (PLC) technique for correcting the luminance or color of an individual pixel to maintain screen uniformity.

For example, when the second pixel data of the input video is provided, the video compensation part 131 can set compensation values for compensating for luminance deviation between the pixels when the black data is sequentially written to the pixels in units of pixel lines during the vertical blank period V-Blank and luminance deviation due to a difference between the emission period of the pixels and the vertical blank period, thereby improving the luminance uniformity and the grayscale expression of the pixels.

The internal signal generation part 132 can be provided with a control command signal related to the black data from the set 220 via a communication interface. For example, when a command signal that is the control command signal is provided from the set 220, the internal signal generation part 132 can generate the internal data enable signal IN-DE using at least one algorithm. The internal data enable signal IN-DE can be interpreted as a virtual data signal. Detailed description thereof will be provided below.

The signal output part 133 can output at least one of the GIP signal, embedded point-to-point interface (EPI) data, and the black data in one frame under the control of the timing controller 130.

For example, when the internal data enable signal IN-DE is generated, the signal output part 133 can output the black data during the vertical blank period in one frame based on the internal data enable signal IN-DE under the control of the timing controller 130.

The black data can be processed through Gate Driver/Source Driver—GIP/D-IC Ctrl (GDSD) that is the display panel driving circuit, under the control of the timing controller 130. In this way, the black data is written before the image quality compensation algorithm processing of the timing controller 130, and as a result, an error that can occur can be prevented.

The timing controller 130 can control Gate Driver/Source Driver—GIP/D-IC Ctrl (GDSD) that is the display panel driving circuit, while distinguishing between a first period and a second period in one frame.

The timing controller 130 can control Gate Driver/Source Driver—GIP/D-IC Ctrl (GDSD) to output the GIP signal and the EPI data as pixel data of the input video subjected to the compensation algorithm processing during an active interval as the first period and output the black data to the EPI during the vertical blank period V-Blank as the second period.

While the black data is output, the data enable signal DE may not be present. The timing controller 130 can generate a GIP signal (GIP Sync) that is the internal data enable signal IN-DE, through the internal signal generation part 132 under the condition that the data enable signal DE is not input. The GIP signal (GIP Sync) that is the internal data enable signal IN-DE can be substantially the same as the cycle of the data enable signal DE input from the pixel data of the input video.

Referring to FIG. 5, the first pixel data of the input video can be output substantially at the same data transmission speed as the pixel data of the input video input from the PC 210 under the control of the set 220.

The set 220 can write the pixel data of the input video to the frame memory 230 with a frequency of a 240 Hz video, read the same data substantially at the same speed as the 240 Hz video at the time of reading, and transmit data to the timing controller 130.

In this way, referring to FIG. 6, the set 220 can make the data transmission speed of the first pixel data of the input video and the data transmission speed of the second pixel data of the input video different from each other.

For example, the second pixel data of the input video can be output at a transmission speed higher than the pixel data of the input video input from the PC 210 under the control of the set 220.

The set 220 can further secure the vertical blank period V-Blank that is a surplus time after an enable period in one frame, by increasing a transmission speed during an enable period relative to a frame frequency when outputting the second pixel data of the input video.

For example, the set 220 can secure or expand the vertical blank period V-Blank that is a surplus period other than the writing period in which data is written, in one frame, by increasing the data transmission speed of the pixel data of the input video that is the input signal provided from the PC 210, by two times.

When the input signal of 240 Hz is received from the PC 210, the cycle of one frame written to the frame memory 230 is equally 240 Hz; however, the vertical blank period V-Blank in the cycle of one frame can be secured or expanded by increasing the data transmission speed during the enable period relative to the frame frequency for the second pixel data of the input video output from the set (SET) 220.

In FIGS. 5 and 6, an arrow with “Video Addressing (Image Data Addressing)” can represent an addressing direction of the pixel data in which the first pixel data or the second pixel data of the input video is sequentially written to the pixels in units of pixel lines.

An arrow with “Black Addressing” can represent an addressing direction of the black data in which the black data set irrelevant to the input video is sequentially written to the pixels in units of pixel lines.

In FIGS. 5 and 6, “P1” is an emission period of the pixels, and “P2” is a black period in which a black grayscale voltage is maintained in the pixels during the vertical blank period. Here, the black period can be interpreted as a black data insertion (hereinafter, referred to as “BDI”) period.

Referring to FIG. 5, when the first pixel data is provided, the timing controller 130 can form one frame period (F0, F1, F2) as an emission period P1 based on the first pixel data. Here, the emission period P1 can be interpreted as a first period, an active period, or a pixel driving period.

The first period P1 can include an addressing period of the first pixel data in which the first pixel data is sequentially written to the pixels in units of pixel lines and the emission period P1 in which the pixels emit light.

During the first period P1, the data driver 110 can output the data voltage corresponding to the first pixel data of the input video, and the gate driver 120 can output the gate signals SCAN and SENSE that are synchronized with the data voltage of the first pixel data.

Accordingly, during the first period P1, after the first pixel data of the input video is sequentially written to the pixels in units of pixel line, the light-emitting element can emit light with target luminance corresponding to the grayscale value of the first pixel data.

On the other hand, referring to FIG. 6, when the second pixel data is provided, the timing controller 130 can form one frame period (F0, F1, F2) as an emission period P1 and a vertical blank period P2.

One frame period (F0, F1, F2) can be made of the emission period P1 and the vertical blank period P2 that is a surplus time after the emission period. Here, the vertical blank period P2 can be referred to as a second period.

The first period P1 can include an addressing period of the second pixel data in which the second pixel data is sequentially written to the pixels in units of pixel lines, and an emission period P1 in which the pixels emit light.

Accordingly, during the first period P1, after the second pixel data of the input video is sequentially written to the pixels in units of pixel lines, the light-emitting element can emit light with target luminance corresponding to the grayscale value of the second pixel data.

As described above, during the first period P1, the second pixel data can be sequentially written to the pixels while the pulses of the gate signals are shifted from the first pixel line L1 to the n-th (where n is an integer equal to or greater than two) pixel line L(n). After the second pixel data is addressed in this manner, during the emission period P1, the light-emitting elements of the pixels can emit light with target luminance corresponding to the grayscale value of the second pixel data.

During the first period P1, the pixel can be driven to emit light according to the second pixel data of the input video.

The first period P1 can further include a real time sensing (RT) period in which the electrical characteristics of the pixels are sensed. In the RT period, sensing can be performed for one line of the display panel 100 during a sensing period to compensate for the mobility of the driving transistor M1, thereby improving short-term restorative afterimage due to temperature or light.

During the second period P2, the black data set irrelevant to the input video can be sequentially written to the pixels in units of pixel lines, and the electrical characteristics of the pixels can be sensed. The second period P2 can include an addressing period of the black data in which the black data is sequentially written to the pixels in units of pixel line and a BDI period that is a black period in which the black grayscale voltage charged in the pixels is maintained and the pixels are maintained in a turn-off state.

During the black period P2 that is the second period, the data driver 110 can output the black grayscale voltage corresponding to the black data. During the second period P2, the gate driver 120 can output the gate signals SCAN and SENSE that are synchronized with the black grayscale voltage.

During the second period P2, the second pixel data can be sequentially written to the pixels while the pulses of the gate signals are shifted from the first pixel line L1 to the n-th pixel line L(n). After the black data is addressed in this manner, the black grayscale voltage charged in the pixels can be maintained during the black period P2.

During the second period P2, because the black grayscale voltage is applied to the gate electrode of the driving transistor M1 in each of the sub-pixels, the driving transistor M1 can be maintained in the off state. Accordingly, the light-emitting element EL does not emit light and is in the turn-off state in the sub-pixels during the second period P2.

A sensing period RT illustrated in FIG. 6 is an example of a real time sensing period set immediately after the first period P1 in which the pixels are driven, for every frame period, but embodiments of the present disclosure are not limited thereto.

In the case of the first pixel data described above, because the second period P2 is a surplus time secured excluding the pixel driving period in one frame period corresponding to the data transmission speed and the like, the second period P2 is substantially relatively shorter than the first period P1.

In the case of the second pixel data, because the second period P2 is a surplus time further secured after the pixel driving period is reduced in one frame period corresponding to the data transmission speed and the like under the control of the set 220, the second period P2 can be similar to or longer than the first period P1.

Therefore, according to the embodiment of the present disclosure, because the black period, for example, the second period P2 can be sufficiently secured, motion blur can be improved by outputting the black data during the second period P2 and reducing the emission period.

FIG. 7 is a diagram illustrating the internal data enable signal according to the embodiment of the present disclosure.

In FIG. 7, “Frame Active” can be the first period P1, and “Frame Blank” can be the second period P2.

The data enable signal DE can be divided into DE_Active and DE_Blank.

During a Frame Active interval, DE_Blank can be referred to as an interval in which DE=0, for example, Horizontal Blank. For example, in Frame Active, the data enable signal DE can be toggled by the number of lines, and an interval in which DE=1 can be referred to as DE_Active.

A region excluding Frame Active in one frame period is referred to as the vertical blank period V-Blank or Frame Blank, and because DE is constantly 0 in the corresponding interval, DE_Blank can be interpreted as the vertical blank period V-Blank.

Referring to FIG. 7, the timing controller 130 can generate the GIP signal (GIP Sync) that is the internal data enable signal IN-DE, through the internal signal generation part 132 under the condition that the data enable signal DE is not input.

The internal data enable signal IN-DE can be toggled such that the black data is sequentially written to the pixels in units of pixel lines during the vertical blank period V-Blank, under the control of the timing controller 130.

The internal data enable signal IN-DE can have substantially the same frequency as the data enable signal DE that is sequentially written to the pixels in units of pixel lines during the pixel driving period. For example, the GIP signal (GIP Sync) that is the internal data enable signal IN-DE can be substantially the same as the cycle of the data enable signal DE input from the pixel data of the input video.

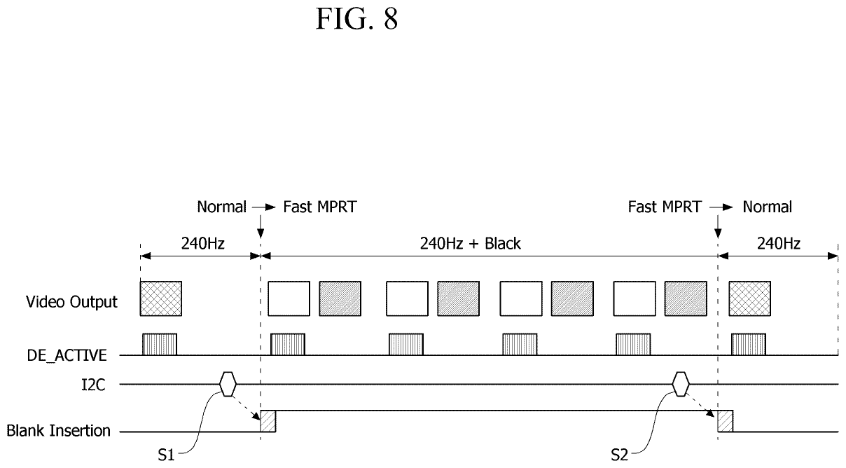

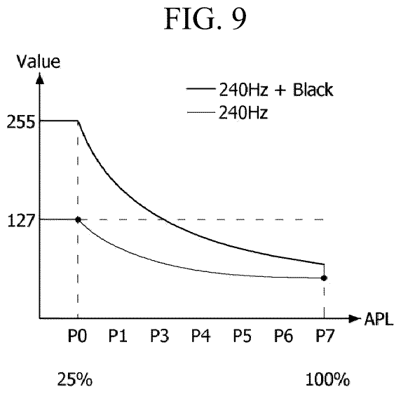

FIG. 8 is a diagram illustrating driving in a first driving mode and a second driving mode according to the embodiment of the present disclosure. FIG. 9 is a diagram illustrating change in PLC Gain according to the embodiment of the present disclosure.

In FIG. 8, Normal represents a normal mode, and Fast MPRT represents a fast MPRT mode. Video Output represents that pixel data or black data is written to the pixels, DE_Active represents that data is successively written in one frame period, I2C represents that a command signal is transmitted, and Blank Insertion represents a period in which black data is written during the vertical blank period. In FIG. 9, a horizontal direction represents an average picture level (APL), and a vertical direction represents a value.

Referring to FIG. 8, the display device can be driven in the first driving mode and the second driving mode under the control of the timing controller 130. The first driving mode can be interpreted as the normal mode, and the second driving mode can be interpreted as the fast moving picture response time mode (fast MPRT mode).

For example, the timing controller 130 can be driven in the first driving mode when the first pixel data of the input video is received from the set 220, and can be driven in the second driving mode when the second pixel data of the input video is received from the set 220.

The timing controller 130 can write the first pixel data to the pixels during one frame period in the first driving mode. For example, the timing controller 130 may not write the black data to the pixels during the vertical blank period in the normal mode for every frame period.

In the second driving mode, the timing controller 130 can write the second pixel data to the pixels during a writing period of one frame period and can write the black data to the pixels during the vertical blank period. A period in which the black data is written to the pixels during the vertical blank period can be interpreted as a black data insertion (BDI) period.

The timing controller 130 can write the black data to the pixels during the vertical blank period that is a surplus time, to drive the pixels for every frame period in the fast MPRT mode.

In the second driving mode, the pixels are driven while the black data is written during the vertical blank period, and as a result, luminance can be decreased compared to the first driving mode.

Therefore, the timing controller 130 can set the compensation values for compensating for luminance deviation between the pixels during the second driving mode and luminance deviation due to the difference between the emission period of the pixels and the vertical blank period, thereby improving the luminance uniformity and grayscale expression of the pixels.

The black data can be written to the pixels through Gate Driver/Source Driver—GIP/D-IC Ctrl (GDSD) during the vertical blank period under the control of the timing controller 130.

The set (SET) 220 can provide the command signal that is the control command signal related to the black data, to the timing controller 130 via the communication interface.

For example, the set (SET) 220 can transmit the command signal through I2C when controlling the first driving mode or the second driving mode of the timing controller 130. Here, I2C can be configured between the set (SET) 220 and the timing controller 130.

The command signal can include a first command signal S1 and a second command signal S2.

The first command signal S1 can be a signal for switching from the normal mode to the fast MPRT mode. The second command signal S2 can be a signal for switching from the fast MPRT mode to the normal mode.

The set (SET) 220 can determine switching or entrance from the normal mode to the fast MPRT mode by transmitting the first command signal S1 to the timing controller 130 through I2C. On the other hand, the set (SET) 220 can determine switching or entrance from the fast MPRT mode to the normal mode by transmitting the second command signal S2 to the timing controller 130 through I2C.

This is because the set (SET) 220 can determine whether to expand the vertical blank period (V-blank) through an input condition and an output condition of the PC 210. Here, expanding the vertical blank period (V-Blank) can be interpreted as securing the vertical blank period V-Blank in one frame period, generating the vertical blank period (V-Blank) in one frame period, or the like.

Further, to maintain luminance corresponding to each mode at the time of switching to the normal mode or the fast MPRT mode, the set (SET) 220 can also transmit a signal for changing a PLC Gain value to the timing controller 130 through I2C.

For example, as illustrated in FIG. 9, to maintain luminance at the time of mode switching, the set (SET) 220 can transmit the signal for changing the PLC Gain value to the timing controller 130 through I2C by increasing PLC Gain two times. Embodiments of the present disclosure are not limited thereto, and the signal for changing the PLC Gain value can be transmitted to the timing controller 130 through I2C along with the first command signal S1 or the second command signal S2.

As described above, the reason for changing the PLC Gain is to compensate for luminance when the black data is written during the vertical blank period. The black data being written during the vertical blank period can be interpreted as black data insertion (BDI).

For example, while the luminance that is recognized by human eye is a cumulative value of brightness, at the time of output with the same brightness, when the black data is written during the vertical blank period, the cumulative value is ½, and accordingly, luminance is decreased to half. In this case, while instantaneous brightness is increased two times when the PLC Gain is increased two times, 50% black data is applied, and the luminance that is recognized by human eye is the same as before the black data is written during the vertical blank period, and there is an advantage that mode switching is smoothly performed. Further, there is also an effect of making the overall luminance bright to increase recognized image quality.

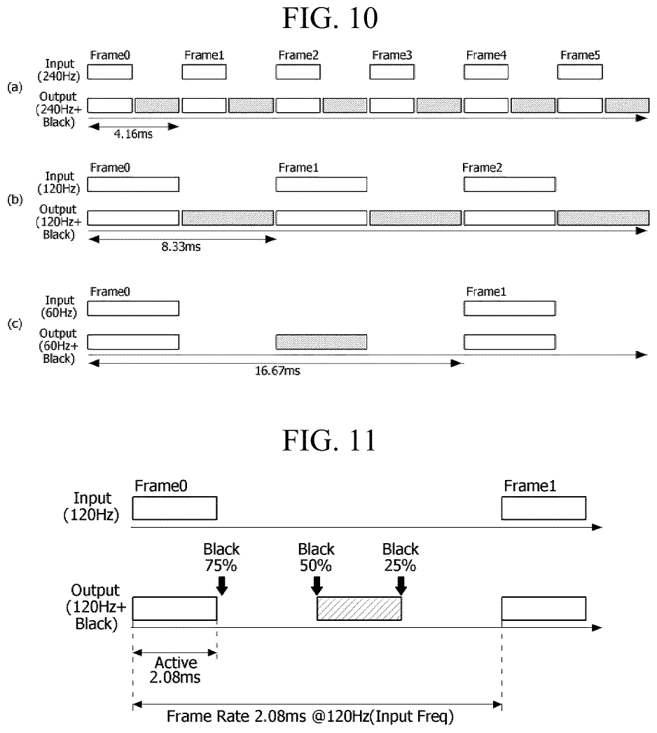

FIG. 10, including (a), (b), and (c), illustrates diagrams illustrating a case where the black data is written during the vertical blank period at various frequencies according to the embodiment of the present disclosure.

Referring to FIG. 10, when the second pixel data of the input video is provided from the set (SET) 220, the timing controller 130 can write the second pixel data to the pixels during the writing period of one frame period, and can write the black data to the pixels during the vertical blank period that is a surplus period remaining after writing.

For example, the timing controller 130 can receive the expanded vertical blank period V-Blank from the set (SET) 220 and can drive Gate Driver/Source Driver—GIP/D-IC Ctrl (GDSD) during the vertical blank period V-Blank to apply the black data. Here, the expanded vertical blank period V-Blank can be a fixed frequency.

The timing controller 130 can analyze a video frame rate in the second pixel data of the input video provided from the set (SET) 220 and apply the black data corresponding to the video frame rate to the pixels based on an analysis result to drive the pixels.

As illustrated in (a) of FIG. 10, when the second pixel data of the input video is input at 240 Hz, the timing controller 130 can write the second pixel data to the pixels based on 240 Hz, and can write the black data to the pixels during the vertical blank period that is a surplus period remaining after writing. In this case, one frame period can be about 4.16 ms.

As illustrated in (b) of FIG. 10, when the second pixel data of the input video is received at 120 Hz, the timing controller 130 can write the second pixel data to the pixels based on 120 Hz, and can write the black data to the pixels during the vertical blank period that is a surplus period remaining after writing. In this case, one frame period can be about 8.33 ms.

For example, SONY PlayStation can output up to 120 Hz, and in this case, the timing controller 130 can write each of the second pixel data and the black data to the pixels based on 120 Hz+Blank Insertion, thereby improving motion blur without side effects.

As illustrated in (c) of FIG. 10, when the second pixel data of the input video is input at 60 Hz, the timing controller 130 can write the second pixel data to the pixels based on 60 Hz, and can write the black data to the pixels during the vertical blank period that is a surplus period remaining after writing. In this case, one frame period can be about 16.67 ms.

For example, when a video source is 60 Hz (for example, YouTube or Netflix), the PC can output a video at 60 Hz, and the set 220 that receives the video can increase a DE transmission speed to expand V-Blank and output the expanded V-blank. Therefore, the timing controller 130 can write each of the second pixel data and the black data to the pixels based on 60 Hz +Blank Insertion, thereby improving motion blur without side effects.

As described above, the timing controller 130 can write the black data to the pixels during the vertical blank period at an optimum frequency matching the video frame rate, thereby improving motion blur without side effects. For example, the timing controller 130 can most efficiently improve the MPRT in writing the black data while maintaining a refresh rate matching the contents of the PC.

FIG. 11 is a diagram illustrating controlling a ratio of the black period in which the black data is written during the vertical blank period, according to the embodiment of the present disclosure.

Referring to FIG. 11, when the second pixel data of the input video is input at 120 Hz, the timing controller 130 can write the second pixel data to the pixels based on 120 Hz, and can make a start point different at which the black data is written to the pixels during the vertical blank period that is a surplus period remaining after writing. When the start point at which the black data is written is made different, the entire period relative to the black period in which the black data is written or maintained can be different. With this, the timing controller 130 can adjust a black insertion duty.

The timing controller 130 can vary the black period by making the start point (or a black start point) of the black period during the vertical blank period different, thereby controlling the black insertion duty (or a black duty).

For example, the timing controller 130 can set a default for the black insertion duty to 50%. This can be interpreted as a reference black insertion duty. For example, when the black insertion duty is set to 50%, in one frame, the emission period can be about 50% and the black period can be about 50%.

When the start point of the black period is earlier than a start point of a black period of the reference black insertion duty, the black period can be relatively extended during the vertical blank period. Therefore, control can be performed at the black insertion duty higher than the reference black insertion duty. For example, when the black insertion duty is set to 75%, in one frame, the emission period can be about 25% and the black period can be about 75%.

When the start point of the black period is later than the start point of the black period of the reference black insertion duty, the black period can be relatively shortened during the vertical blank period. Therefore, control can be performed at the black insertion duty lower than the reference black insertion duty. For example, when the black insertion duty (BI Duty) is set to 25%, in one frame, the emission period can be about 75% and the black period can be about 25%.

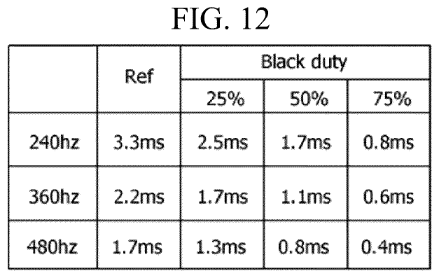

FIG. 12 is a diagram illustrating a simulation value of the MPRT with the refresh rate and black insertion application according to the embodiment of the present disclosure.

In FIG. 12, a horizontal direction of a table represents a black insertion duty (BI Duty), and a vertical direction represents a refresh rate. A simulation value of a response time (R/T) has been measured while changing the refresh rate and the black period.

For example, in the case of a refresh rate of a 240 Hz input video, a reference response time (R/T) is 3.3 ms. In the case of the refresh rate of 240 Hz input video, it can be understood that the reference response time (R/T) with respect to the black insertion duty (BI duty) is 2.6 ms when the black insertion duty is 25%, 1.7 ms when the black insertion duty is 50%, and 0.8 ms when the black insertion duty is 75%.

In the case of a refresh rate of a 360 Hz input video, the reference response time (R/T) is 2.2 ms. In the case of the refresh rate of 360 Hz input video, it can be understood that the reference response time (R/T) with respect to the black insertion duty (BI Duty) is 1.7 ms when the black insertion duty is 25%, 1.1 ms when the black insertion duty is 50%, and 0.8 ms when the black insertion duty is 75%.

In the case of a refresh rate of a 480 Hz input video, the reference response time (R/T) is 1.7 ms. In the case of the refresh rate of the 480 Hz input video, it can be understood that the reference response time (R/T) with respect to the black insertion duty (BI Duty) is 1.3 ms when the black insertion duty is 25%, 0.8 ms when the black insertion duty is 50%, and 0.4 ms when the black insertion duty is 75%.

With this, it can be understood that the reference response time (R/T) for the refresh rate of the 480 Hz input video is substantially the same as the reference response time (R/T) with respect to the black insertion duty (BI Duty) of 50% for the refresh rate of the 240 Hz input video. For example, it can be understood that, in the case of 240 Hz+BI, a moving picture characteristic equivalent to 480 Hz can be secured. It can be confirmed that the moving picture characteristic is improved with a small number of GPU resources through black insertion.

Further, compared to when the video frame rate is different, for example, when a 120 Hz input video is driven at 480 Hz, when black insertion driving matching the video frame rate is performed, for example, when the 120 Hz input video is driven with 120 Hz +black insertion, a moving picture characteristic corresponding to the level of 240 Hz (120 Hz×2) can be obtained.

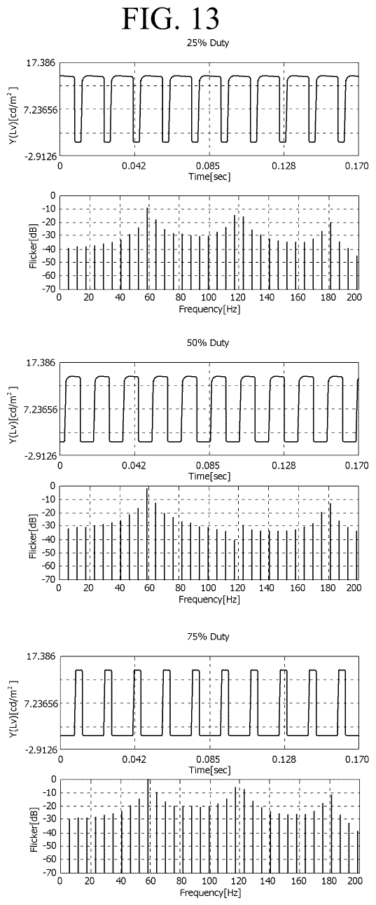

FIG. 13, including (a), (b) and (c), illustrates diagrams illustrating a relationship between the MPRT and flicker according to the embodiment of the present disclosure.

A ratio of an emission period and a black time can be different according to the black duty. Examples of 25%, 50%, and 75% correspond to (a), (b), and (c) of FIG. 13, respectively.

Referring to (a), (b), and (c) of FIG. 13, the timing controller 130 according to the embodiment of the present disclosure can determine a black insertion duty (BI duty) using a relatively long vertical blank period V-Blank for 60 Hz (black application point), thereby responding to various options.

For example, the timing controller 130 can analyze the pixel data of the input video, the control command signal, and the like provided via the set 220, perform control of increasing the black insertion duty (BI Duty) to improve the MPRT in the case of a moving image based on a value of an analysis result, and perform control of decreasing the black insertion duty (BI Duty) to improve flicker in the case of a still image.

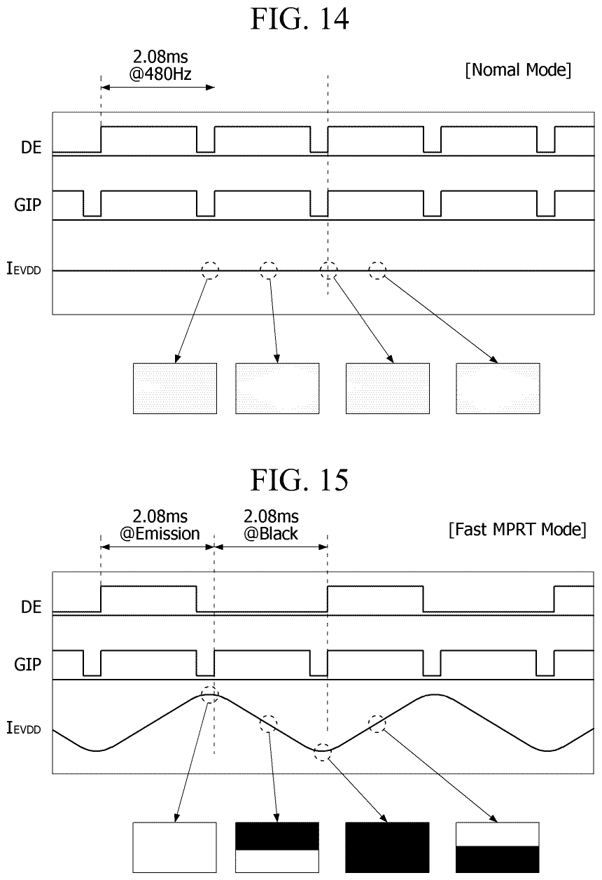

FIGS. 14 and 15 are diagrams illustrating driving in the normal mode and the fast MPRT mode according to the embodiment of the present disclosure.

In these examples, signals in FIGS. 14 and 15 are measured based on a Hold & Sample driving method.

Referring to FIG. 14, the timing controller 130 can generate the data enable signal DE in the case of the normal mode, and can generate the GIP signal based on the data enable signal DE. Here, the data enable signal DE can be a V×1 signal received from the set (SET) 220. The GIP signal can be a clock signal that is transmitted to the panel GIP via the level shifter.

Further, at the time of output of a fixed pattern in the normal mode, a current IEVDD flowing in EVDD can be the same.

Referring to FIG. 15, when the timing controller 130 is in the fast MPRT mode, a blank between the inputs of the data enable signal DE can be extended due to the expansion of the vertical blank period V-Blank, and the GIP signal for black insertion can be generated and output between the inputs of the data enable signal DE.

As described above, the timing controller 130 can generate the internal data enable signal IN-DE between the inputs of the data enable signal DE with the expansion of the vertical blank period V-Blank. The GIP signal can be generated based on the internal data enable signal IN-DE and can be written during the expanded vertical blank period V-Blank.

Further, at the time of black insertion in the fast MPRT mode, because an amount of application of the black data is different by time, the current IEVDD flowing in EVDD can be varied even at the time of output of the fixed pattern.

For example, the display device according to the embodiments of the present disclosure can be applied to mobile devices, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, e-books, portable multimedia players (PMPs), personal digital assistants (PDAs), MP3 players, mobile medical devices, desktop personal computers (PCs)s, laptop PCs, netbook computers, workstations, navigation devices, vehicle display devices, theater display devices, televisions, wallpaper devices, signage devices, gaming devices, laptops, monitors, cameras, camcorders, household appliances, and the like.

The foregoing description of the problems to be solved, the means for solving such problems, and the effects thereof is not intended to define the essential features of the claims, and the scope of the claims shall not be limited by the matters described in the disclosure.

Accordingly, the embodiments disclosed herein are to be considered descriptive and not restrictive of the technical spirit of the present invention, and the scope of the technical spirit of the present invention is not limited by these embodiments. Accordingly, the above-described embodiments should be understood to be examples and not limiting in any aspect. The scope of the present invention should be construed by the appended claims, and all technical ideas within the scope of their equivalents should be construed as being included in the scope of the present invention.

### LIST OF REFERENCE NUMBERS

100: Display panel
110: Data driver
120: Gate driver
130: Timing controller
140: Level shifter
150: Power supply
FRn, FRn+1: Frame period
P1: First period
P2: Second period

What is claimed is:

1. A display device comprising:
a display panel in which data lines, gate lines, and pixel lines are disposed, each of the pixel lines having pixels disposed therein;
a data driver connected to the data lines;
a gate driver connected to the gate lines; and
a timing controller configured to receive first pixel data of an input video or second pixel data of the input video from a set, and control the data driver and the gate driver based on the received pixel data,
wherein the set is configured to make a transmission speed of the first pixel data and a transmission speed of the second pixel data different from each other,
wherein the timing controller is configured to write, when the second pixel data is received from the set at a transmission speed faster than the first pixel data, the second pixel data to the pixels during a writing period in one frame including a vertical blank period generated by the faster transmission speed, and then, write black data having a black grayscale value to the pixels during the vertical blank period.

2. The display device according to claim 1,
wherein the timing controller is configured to:
set a first driving mode in which the first pixel data is written to the pixels during the writing period of the one frame and the black data is not written to the pixels during the vertical blank period, and
set a second driving mode in which the second pixel data is written to the pixels during the writing period of the one frame and the black data is written to the pixels during the vertical blank period.

3. The display device according to claim 2, wherein a video frame rate of writing the black data corresponds to a video frame rate of the second pixel data.

4. The display device according to claim 2, wherein the timing controller is configured to generate an internal data enable signal (IN-DE) using at least one algorithm when a command signal related to the black data is received from the set via a communication interface.

5. The display device according to claim 4,
wherein the timing controller is configured to:
generate a gate-in-panel (GIP) signal based on a data enable signal (DE) provided from the set during the writing period in the first driving mode or the second driving mode, and
generate the GIP signal based on the internal data enable signal (IN-DE) during the vertical blank period with no data enable signal (DE) in the second driving mode.

6. The display device according to claim 5, wherein a cycle of the internal data enable signal (IN-DE) is the same as a cycle of the data enable signal (DE).

7. The display device according to claim 6, wherein the set is configured to control a data transmission speed of the second pixel data output to the timing controller to be faster than a data transmission speed of an input video input from a computer to expand the vertical blank period in the one frame.

8. The display device according to claim 7, wherein the set is configured to transmit a command signal to the timing controller via the communication interface during driving in the first driving mode or the second driving mode.

9. The display device according to claim 8,
wherein the command signal includes
a first command signal for controlling switching or entrance from the first driving mode to the second driving mode, and
a second command signal for controlling switching or entrance from the second driving mode to the first driving mode.

10. The display device according to claim 9, wherein the writing period further includes a real time sensing (RT) period in which electrical characteristics of the pixels are sensed.

11. The display device according to claim 10, wherein the timing controller is configured to set, when the second pixel data is provided, a compensation value for compensating for each of a luminance deviation between the pixels as the black data is sequentially written to the pixels during the vertical blank period (V-Blank) and a luminance deviation due to a difference between an emission period of the pixels and the vertical blank period.

12. A method for driving a display device including a set and a timing controller, the method comprising:
writing first pixel data of an input video or second pixel data of the input video under control of the set, wherein the set is configured to make a transmission speed of the first pixel data and a transmission speed of the second pixel data different from each other;
setting a transmission frequency of the second pixel data of the input video to be higher than a transmission frequency of the written first pixel data of the input video;
expanding a vertical blank period that is a surplus period other than a writing period in one frame, through the higher transmission frequency;
writing the first pixel data or the second pixel data to pixels of a display panel during the writing period of the one frame under control of the timing controller; and
writing black data having a black grayscale value to the pixels during the vertical blank period.

13. The method for driving a display device according to claim 12, further comprising:
under control of the timing controller,
setting a first driving mode in which the first pixel data is written to the pixels during the writing period of the one frame and the black data is not written during the vertical blank period; and
setting a second driving mode in which the second pixel data is written to the pixels during the writing period of the one frame and the black data is written during the vertical blank period.

14. The method for driving a display device according to claim 13, further comprising:
under control of the timing controller, when a command signal related to the black data is received from the set via a communication interface, generating an internal data enable signal (IN-DE) using at least one algorithm.

15. The method for driving a display device according to claim 14, further comprising:
under control of the timing controller,
generating a gate-in-panel (GIP) signal based on the data enable signal (DE) provided from the set during the writing period in the first driving mode or the second driving mode; and
generating the GIP signal based on the internal data enable signal (IN-DE) during the vertical blank period in which the data enable signal (DE) is not present, in the second driving mode.

16. The method for driving a display device according to claim 15, wherein a cycle of the internal data enable signal (IN-DE) is the same as a cycle of the data enable signal (DE).

17. The method for driving a display device according to claim 16, wherein, under control of the set, a data transmission speed of the second pixel data that is output to the timing controller is controlled to be faster than a data transmission speed of an input video input from a PC to expand the vertical blank period in the one frame.

18. The method for driving a display device according to claim 17, wherein, under control of the set, a command signal is transmitted to the timing controller via the communication interface during driving in the first driving mode or the second driving mode.

19. The method for driving a display device according to claim 18,
wherein the command signal includes
a first command signal for controlling switching or entrance from the first driving mode to the second driving mode, and
a second command signal for controlling switching or entrance from the second driving mode to the first driving mode.

20. The method for driving a display device according to claim 19, wherein the writing period further includes a real time sensing (RT) period in which electrical characteristics of the pixels are sensed.

21. The method for driving a display device according to claim 20, further comprising:
when the second pixel data is provided, setting compensation values for compensating for a luminance deviation when the black data is sequentially written to the pixels in units of pixel lines during the vertical blank period and a luminance deviation due to a difference between an emission period of the pixels and the vertical blank period under control of the timing controller.
